(19) United States
(12) Patent Application Publication
(10) Pub. No.: US 2025/0240163 A1
(43) Pub. Date: Jul. 24, 2025

(54) COMMUNICATION METHOD, FIRST DEVICE, AND SECOND DEVICE

(71) Applicant: Panasonic Intellectual Property Management Co., Ltd., Osaka (JP)

(72) Inventors: Yasushi TAKAHASHI, Fukuoka (JP); Saburo TOYONAGA, Fukuoka (JP); Yuji UNAGAMI, Osaka (JP); Kenjiro IKE, Fukuoka (JP); Naohisa NISHIDA, Kanagawa (JP)

(73) Assignee: Panasonic Intellectual Property Management Co., Ltd., Osaka (JP)

(21) Appl. No.: 19/172,013

(22) Filed: Apr. 7, 2025

Related U.S. Application Data
(63) Continuation of application No. PCT/JP2023/034112, filed on Sep. 20, 2023.

(30) Foreign Application Priority Data
Oct. 14, 2022 (JP) 2022-165328

(51) Int. Cl. H04L 9/14; H04L 9/32; H04L 9/40

(52) U.S. Cl. CPC H04L 9/14; H04L 9/3247; H04L 63/205

(57) ABSTRACT

According to a communication method, a first device (a terminal device) transmits, to a second device (a terminal device), a certificate for a first encryption scheme, which includes a confirmation flag indicating that the first device supports a different encryption scheme from the first encryption scheme, when the first device receives a message that includes a nonce and the confirmation flag as a response from the second device to transmission of the certificate, the first device transmits, to the second device, a signature generated based on the nonce and the confirmation flag that are included in the message received, and when the first device receives a message that includes a nonce and does not include the confirmation flag as a response from the second device to transmission of the certificate, the first device transmits, to the second device, a signature generated based on the nonce included in the message received.

### CROSS REFERENCE TO RELATED APPLICATIONS

This is a continuation application of PCT International Application No. PCT/JP2023/034112 filed on Sep. 20, 2023, designating the United States of America, which is based on and claims priority of Japanese Patent Application No. 2022-165328 filed on Oct. 14, 2022. The entire disclosures of the above-identified applications, including the specifications, drawings and claims are incorporated herein by reference in their entirety.

### FIELD

The present disclosure relates to a communication method, a first device, and a second device.

### BACKGROUND

Patent Literature (PTL) 1 discloses a method for a cryptosystem used by an application in a company system to transition to a hybrid method that is a combination of a so-called classic encryption scheme and a post quantum cryptography (PQC) scheme.

### CITATION LIST

### Patent Literature

PTL 1: International Publication No. WO2020/087152

### SUMMARY

### Technical Problem

The present disclosure provides a communication method, for instance, for more appropriately applying a hybrid scheme.

### Solution to Problem

A communication method according to an aspect of the present disclosure is a communication method for use in a first device in communication between the first device and a second device, the communication method including: transmitting, by the first device, a certificate for a first encryption scheme to the second device, the certificate including a confirmation flag indicating that the first device supports a different encryption scheme from the first encryption scheme; when the first device receives a message that includes a nonce and the confirmation flag as a response from the second device to transmission of the certificate, transmitting, by the first device to the second device, a signature generated based on the nonce and the confirmation flag that are included in the message received; and when the first device receives a message that includes a nonce and does not include the confirmation flag as a response from the second device to transmission of the certificate, transmitting, by the first device to the second device, a signature generated based on the nonce included in the message received.

A communication method according to another aspect of the present disclosure is a communication method for use in a second device in communication between a first device and the second device, the communication method including: receiving, by the second device, a certificate for a first encryption scheme from the first device, the certificate including a confirmation flag indicating that the first device supports a different encryption scheme from the first encryption scheme; when the second device supports the different encryption scheme, transmitting, by the second device to the first device, a message that includes a nonce and the confirmation flag as a response to the certificate received; when the second device does not support the different encryption scheme, transmitting, by the second device to the first device, a message that includes a nonce and does not include the confirmation flag as a response to the certificate received; and receiving, by the second device from the first device, a signature generated based on the nonce included in the message transmitted or a signature generated based on the nonce and the confirmation flag that are included in the message transmitted.

A first device according to an aspect of the present disclosure is a first device communicable with a second device, the first device including: a certificate generator that generates a certificate for a first encryption scheme, the certificate including a confirmation flag indicating that the first device supports a different encryption scheme from the first encryption scheme; and a signature generator. When the first device transmits the certificate generated to the second device and receives a message that includes a nonce and the confirmation flag as a response from the second device, the signature generator generates a signature, based on the nonce and the confirmation flag that are included in the message received, and when the first device transmits the certificate generated to the second device and receives a message that includes a nonce and does not include the confirmation flag as a response from the second device, the signature generator generates a signature, based on the nonce included in the message received.

A second device according to an aspect of the present disclosure is a second device communicable with a first device, the second device including: a message generator; and a communicator. When the message generator receives a certificate for a first encryption scheme from the first device, the certificate including a confirmation flag indicating that the first device supports a different encryption scheme from the first encryption scheme, the message generator generates a message that includes a nonce and the confirmation flag as a response to the certificate received, under a condition that the second device supports the different encryption scheme, and the message generator generates a message that includes a nonce and does not include the confirmation flag as a response to the certificate received, under a condition that the second device does not support the different encryption scheme, and the communicator receives, from the first device, a signature generated based on the nonce included in the message transmitted or a signature generated based on the nonce and the confirmation flag that are included in the message transmitted.

Note that these general or specific aspects may be implemented as a device, an integrated circuit, a computer program, or a non-transitory, computer-readable recording medium such as a Compact Disk Read Only Memory (CD-ROM), or may be implemented as any combination of devices, integrated circuits, computer programs, or non-transitory recording media.

### Advantageous Effects

A communication method, for instance, according to the present disclosure more appropriately allows application of a hybrid scheme.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for illustrating an overview of a communication system according to an embodiment.

FIG. 2 is a diagram for illustrating an overview of a communication system according to another example of the embodiment.

FIG. 3 is a block diagram illustrating an example of a functional configuration of a certificate issuing device according to the embodiment.

FIG. 4 is a block diagram illustrating an example of a functional configuration of a common key issuing device according to the embodiment.

FIG. 5 is a block diagram illustrating another example of a functional configuration of a common key issuing device according to the embodiment.

FIG. 6 is a block diagram illustrating an example of a functional configuration of a terminal device according to the embodiment.

FIG. 7 is a block diagram illustrating another example of a functional configuration of a terminal device according to the embodiment.

FIG. 8 is a block diagram illustrating an example of a functional configuration of a terminal device according to the embodiment.

FIG. 9 is a sequence diagram illustrating an example of operation of the communication system according to the embodiment.

FIG. 10 is a sequence diagram illustrating an example of operation of the communication system according to the embodiment.

FIG. 11 is a sequence diagram illustrating an example of operation of the communication system according to the embodiment.

FIG. 12 is a sequence diagram illustrating an example of operation of the communication system according to the embodiment.

FIG. 13 is a sequence diagram illustrating an example of operation of the communication system according to the embodiment.

FIG. 14 is a sequence diagram illustrating an example of operation of the communication system according to the embodiment.

FIG. 15 is a sequence diagram illustrating an example of operation of the communication system according to the embodiment.

FIG. 16 is a sequence diagram illustrating an example of operation of the communication system according to the embodiment.

FIG. 17 is a sequence diagram illustrating an example of operation of the communication system according to the embodiment.

FIG. 18 is a sequence diagram illustrating an example of operation of the communication system according to the embodiment.

FIG. 19 is a sequence diagram illustrating an example of operation of the communication system according to the embodiment.

FIG. 20 is a sequence diagram illustrating an example of operation of the communication system according to the embodiment.

FIG. 21 is a sequence diagram illustrating an example of operation of the communication system according to the embodiment.

FIG. 22 is a sequence diagram illustrating an example of operation of the communication system according to the embodiment.

FIG. 23 illustrates an example of screen display in operation of the communication system according to the embodiment.

FIG. 24 illustrates an example of screen display in operation of the communication system according to the embodiment.

FIG. 25 illustrates an example of screen display in operation of the communication system according to the embodiment.

FIG. 26 illustrates an example of screen display in operation of the communication system according to the embodiment.

FIG. 27 illustrates an example of screen display in operation of the communication system according to the embodiment.

FIG. 28 illustrates an example of screen display in operation of the communication system according to the embodiment.

FIG. 29 illustrates an example of screen display in operation of the communication system according to the embodiment.

FIG. 30 illustrates an example of screen display in operation of the communication system according to the embodiment.

FIG. 31 illustrates an example of screen display in operation of the communication system according to the embodiment.

FIG. 32 illustrates an example of screen display in operation of the communication system according to the embodiment.

FIG. 33 illustrates an example of screen display in operation of the communication system according to the embodiment.

FIG. 34 illustrates an example of screen display in operation of the communication system according to the embodiment.

FIG. 35 illustrates an example of screen display in operation of the communication system according to the embodiment.

FIG. 36 illustrates an example of screen display in operation of the communication system according to the embodiment.

FIG. 37 illustrates an example of screen display in operation of the communication system according to the embodiment.

FIG. 38 illustrates an example of screen display in operation of the communication system according to the embodiment.

FIG. 39 illustrates an example of screen display in operation of the communication system according to the embodiment.

FIG. 40 illustrates an example of screen display in operation of the communication system according to the embodiment.

FIG. 41 illustrates an example of screen display in operation of the communication system according to the embodiment.

FIG. 42 illustrates an example of screen display in operation of the communication system according to the embodiment.

FIG. 43 illustrates an example of screen display in operation of the communication system according to the embodiment.

FIG. 44 illustrates an example of screen display in operation of the communication system according to the embodiment.

FIG. 45 illustrates an example of screen display in operation of the communication system according to the embodiment.

FIG. 46 illustrates an example of screen display in operation of the communication system according to the embodiment.

FIG. 47 illustrates an example of screen display in operation of the communication system according to the embodiment.

FIG. 48 illustrates an example of screen display in operation of the communication system according to the embodiment.

FIG. 49 illustrates an example of screen display in operation of the communication system according to the embodiment.

FIG. 50 illustrates an example of screen display in operation of the communication system according to the embodiment.

FIG. 51 illustrates an example of screen display in operation of the communication system according to the embodiment.

FIG. 52 illustrates an example of screen display in operation of the communication system according to the embodiment.

FIG. 53 is a sequence diagram illustrating an example of operation of the communication system according to a variation of the embodiment.

FIG. 54 is a sequence diagram illustrating an example of operation of the communication system according to the variation of the embodiment.

FIG. 55 is a sequence diagram illustrating an example of operation of the communication system according to the variation of the embodiment.

FIG. 56 is a sequence diagram illustrating an example of operation of the communication system according to the variation of the embodiment.

### DESCRIPTION OF EMBODIMENTS

### Underlying Knowledge Forming Basis of the Present Disclosure

Recently, quantum computers have been actively developed, but on the other hand, it is known that a currently used encryption scheme (hereinafter, a classic encryption scheme or simply a classic scheme) will be theoretically at risk since the quantum computers are becoming large-scale. In view of such circumstances, a new encryption scheme (hereinafter, the Post Quantum Cryptography (PQC) scheme) that can withstand calculation performance of large-scale quantum computers has been proposed and preparation for transition from the classic scheme thereto has been made. However, the PQC scheme has just a short history, so that it cannot be said that safety evaluation has been sufficiently conducted. Stated differently, when the PQC scheme is used as is, the safety of encryption is not ensured. Accordingly, during a transition period until safety evaluation is sufficiently conducted, it is considered that a scheme (hereinafter, a hybrid scheme) of using both the classic scheme and the PQC scheme is to be rather adopted. As a classic scheme, Rivest-Shamir-Adleman (RSA) or the Elliptic Curve Digital Signature Algorithm (ECDSA), for instance, is used.

By the way, the hybrid scheme is effective in maintaining safety for a long period, but requires communication devices to support the scheme. Thus, communication with a conventional device that does not support the hybrid scheme cannot use this scheme (does not have backward compatibility). Accordingly, when devices communicate, each of the devices needs to check whether its communication partner support the hybrid scheme.

In the present disclosure, a communication method for more appropriately applying the hybrid scheme is to be described using an example in which one (a second device) of the devices that communicate with each other authenticates the other device (a first device) and exchange keys. A summary of such a communication method is as below.

First, a non-critical expansion region for checking a hybrid supported state of the second device is added as a confirmation flag to a classic certificate that the first device transmits. The second device reads the flag if the second device supports the hybrid scheme, and returns the confirmation flag together with a nonce. The first device generates a signature by using both the nonce and the confirmation flag that are received. By doing so, for example, when the second device returns the confirmation flag together with a nonce, if the communication is intercepted and only the nonce that has been tampered with is transmitted to the first device, a signature further transmitted by the first device does not include the confirmation flag. Accordingly, the second device can detect that tampering has been made since the nonce and the confirmation flag that are used for transmission do not match those received. Thus, from the viewpoint that the hybrid supported state can be safely checked, the hybrid scheme can be more appropriately applied.

### Summary of the Present Disclosure

A summary of the present disclosure is as follows.

A communication method according to a first aspect of the present disclosure is a communication method for use in a first device in communication between the first device and a second device, the communication method including: transmitting, by the first device, a certificate for a first encryption scheme to the second device, the certificate including a confirmation flag indicating that the first device supports a different encryption scheme from the first encryption scheme; when the first device receives a message that includes a nonce and the confirmation flag as a response from the second device to transmission of the certificate, transmitting, by the first device to the second device, a signature generated based on the nonce and the confirmation flag that are included in the message received; and when the first device receives a message that includes a nonce and does not include the confirmation flag as a response from the second device to transmission of the certificate, transmitting, by the first device to the second device, a signature generated based on the nonce included in the message received.

According to such a communication method, whether the message has been tampered with can be detected if a message transmitted from the second device as a response and a signature received thereafter from the first device are used. Thus, the second device can obtain information for detecting whether the message has been tampered with. Accordingly, from the viewpoint that the hybrid supported state can be safely checked, the hybrid scheme can be more appropriately applied.

A communication method according to a second aspect of the present disclosure is the communication method according to the first aspect in which when the first device receives a detection flag indicating that the message has been tampered with, the first device continues a communication session between the first device and the second device by using the different encryption scheme, the detection flag being generated by the second device, based on a mismatch between the message transmitted by the second device as the response to the transmission of the certificate and the signature transmitted by the first device to the second device in response to reception of the message.

According to this, based on the reception of a detection flag indicating that the message has been tampered with, a communication session between the first device and the second device can be continued under a different encryption scheme.

A communication method according to a third aspect of the present disclosure is the communication method according to the first aspect in which when the first device receives a detection flag indicating that the message has been tampered with, the first device terminates a communication session between the first device and the second device, the detection flag being generated by the second device, based on a mismatch between the message transmitted by the second device as the response to the transmission of the certificate and the signature transmitted by the first device to the second device in response to reception of the message.

According to this, based on the reception of a detection flag that indicates that the message has been tampered with, a communication session between the first device and the second device can be terminated.

A communication method according to a fourth aspect of the present disclosure is the communication method according to any one of the first to third aspects in which the first encryption scheme is a Rivest-Shamir-Adleman (RSA) scheme or an Elliptic Curve Digital Signature Algorithm (ECDSA) scheme, and the different encryption scheme is a Post Quantum Cryptography (PQC) scheme.

According to this, a hybrid scheme of using both the PQC scheme and either the RSA scheme or the ECDSA scheme can be more appropriately applied.

A communication method according to a fifth aspect of the present disclosure is a communication method for use in a second device in communication between a first device and the second device, the communication method including: receiving, by the second device, a certificate for a first encryption scheme from the first device, the certificate including a confirmation flag indicating that the first device supports a different encryption scheme from the first encryption scheme; when the second device supports the different encryption scheme, transmitting, by the second device to the first device, a message that includes a nonce and the confirmation flag as a response to the certificate received; when the second device does not support the different encryption scheme, transmitting, by the second device to the first device, a message that includes a nonce and does not include the confirmation flag as a response to the certificate received; and receiving, by the second device from the first device, a signature generated based on the nonce included in the message transmitted or a signature generated based on the nonce and the confirmation flag included in the message transmitted.

According to this, whether the message has been tampered with can be detected if a message transmitted from the second device as a response and a signature received thereafter from the first device are used. Thus, the second device can obtain information for detecting whether the message has been tampered with. Accordingly, from the viewpoint that the hybrid supported state can be safely checked, the hybrid scheme can be more appropriately applied.

A communication method according to a sixth aspect of the present disclosure is a communication method for communication between a first device and a second device, the communication method including: transmitting, by the first device, a certificate for a first encryption scheme to the second device, the certificate including a confirmation flag indicating that the first device supports a different encryption scheme from the first encryption scheme; when the second device supports the different encryption scheme, transmitting, by the second device to the first device, a message that includes a nonce and the confirmation flag as a response to the certificate received; when the second device does not support the different encryption scheme, transmitting, by the second device to the first device, a message that includes a nonce and does not include the confirmation flag as a response to the certificate received; when the first device receives a message that includes a nonce and the confirmation flag as a response from the second device to transmission of the certificate, transmitting, by the first device to the second device, a signature generated based on the nonce and the confirmation flag that are included in the message received; and when the first device receives a message that includes a nonce and does not include the confirmation flag as a response from the second device to transmission of the certificate, transmitting, by the first device to the second device, a signature generated based on the nonce included in the message received.

According to this, whether the message has been tampered with can be detected if a message transmitted from the second device as a response and a signature received thereafter from the first device are used. Thus, the second device can obtain information for detecting whether the message has been tampered with. Accordingly, from the viewpoint that the hybrid supported state can be safely checked, the hybrid scheme can be more appropriately applied.

A first device according to a seventh aspect of the present disclosure is a first device communicable with a second device, the first device including: a certificate generator that generates a certificate for a first encryption scheme, the certificate including a confirmation flag indicating that the first device supports a different encryption scheme from the first encryption scheme; and a signature generator. When the first device transmits the certificate generated to the second device and receives a message that includes a nonce and the confirmation flag as a response from the second device, the signature generator generates a signature, based on the nonce and the confirmation flag that are included in the message received, and when the first device transmits the certificate generated to the second device and receives a message that includes a nonce and does not include the confirmation flag as a response from the second device, the signature generator generates a signature, based on the nonce included in the message received.

According to this, advantageous effects similar to those yielded by the communication method stated above can be yielded.

A second device according to an eighth aspect of the present disclosure is a second device communicable with a first device, the second device including: a message generator; and a communicator. When the message generator receives a certificate for a first encryption scheme from the first device, the certificate including a confirmation flag indicating that the first device supports a different encryption scheme from the first encryption scheme, the message generator generates a message that includes a nonce and the confirmation flag as a response to the certificate received, under a condition that the second device supports the different encryption scheme, and the message generator generates a message that includes a nonce and does not include the confirmation flag as a response to the certificate received, under a condition that the second device does not support the different encryption scheme, and the communicator receives, from the first device, a signature generated based on the nonce included in the message transmitted or a signature generated based on the nonce and the confirmation flag that are included in the message transmitted.

According to this, advantageous effects similar to those yielded by the communication method stated above can be yielded.

A program according to a ninth aspect of the present disclosure is a program for causing a computer to execute a communication method for communication between a first device and a second device, the communication method including: transmitting, by the first device, a certificate for a first encryption scheme to the second device, the certificate including a confirmation flag indicating that the first device supports a different encryption scheme from the first encryption scheme; when the first device receives a message that includes a nonce and the confirmation flag as a response from the second device to transmission of the certificate, transmitting, by the first device to the second device, a signature generated based on the nonce and the confirmation flag that are included in the message received; and when the first device receives a message that includes a nonce and does not include the confirmation flag as a response from the second device to transmission of the certificate, transmitting, by the first device to the second device, a signature generated based on the nonce included in the message received.

According to this, advantageous effects similar to those yielded by the communication method stated above can be yielded by using a computer.

A program according to a tenth aspect of the present disclosure is a program for causing a computer to execute a communication method for communication between a first device and a second device, the communication method including: receiving, by the second device, a certificate for a first encryption scheme from the first device, the certificate including a confirmation flag indicating that the first device supports a different encryption scheme from the first encryption scheme; when the second device supports the different encryption scheme, transmitting, by the second device to the first device, a message that includes a nonce and the confirmation flag as a response to the certificate received; when the second device does not support the different encryption scheme, transmitting, by the second device to the first device, a message that includes a nonce and does not include the confirmation flag as a response to the certificate received; and receiving, by the second device from the first device, a signature generated based on the nonce included in the message transmitted or a signature generated based on the nonce and the confirmation flag that are included in the message transmitted.

According to this, advantageous effects similar to those yielded by the communication method stated above can be yielded by using a computer.

Note that these general or specific aspects may be implemented as a device, an integrated circuit, a computer program, or a non-transitory, computer-readable recording medium such as a CD-ROM, or may be implemented as any combination of devices, integrated circuits, computer programs, or non-transitory recording media.

Hereinafter, embodiments are to be described in detail with reference to the drawing as appropriate. Note that description that is unnecessarily detailed may be omitted. For example, detailed description of items that are already known well and redundant description of a substantially the same configuration may be omitted. This is intended to avoid the description given below being unnecessarily redundant and to facilitate understanding of those skilled in the art.

Note that the inventors provide accompanied drawings and the following description in order that those skilled in the art fully understand the present disclosure.

### EMBODIMENT

### Configuration

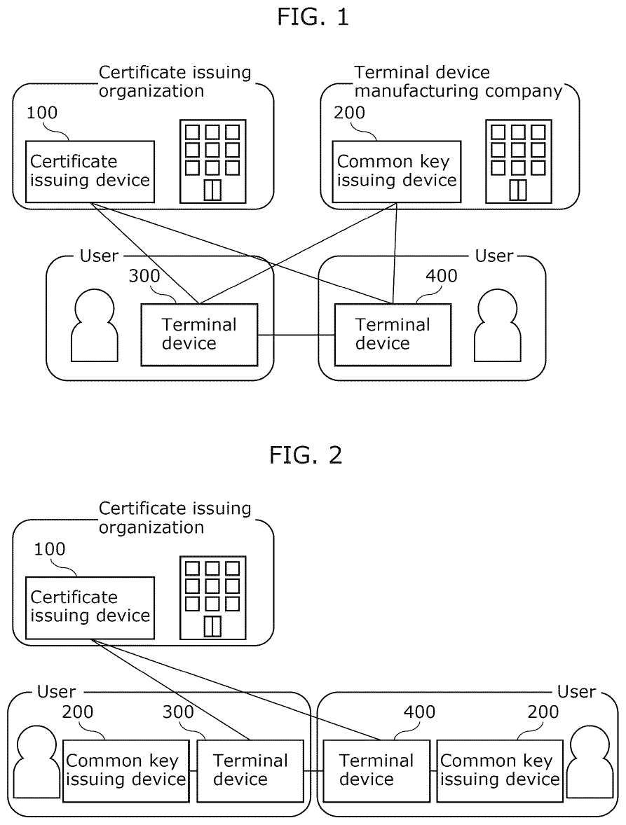

FIG. 1 is a diagram for illustrating an overview of a communication system according to an embodiment. FIG. 1 illustrates terminal device 300 corresponding to a first device and terminal device 400 corresponding to a second device, as devices involved in communication.

Certificate issuing device 100 generates a digital signature certificate for use by a user and transmits the certificate to terminal devices 300 and 400. Certificate issuing device 100 is implemented by, for example, a server device that belongs to a certificate issuing organization.

Common key issuing device 200 generates different common keys for terminal devices 300 and 400 that the users use, and embeds the common keys in terminal devices 300 and 400. Common key issuing device 200 is operated by, for example, a terminal device manufacturing company that manufactures terminal devices 300 and 400. Common key issuing device 200 may generate a common test message and a common flag for terminal devices 300 and 400 that the users use, and embeds the test message and flag in terminal devices 300 and 400.

Terminal device 300 communicates with other terminal devices (with terminal device 400), and performs random number generation processing, signature generation processing, and session key generation processing, for instance. Terminal device 300 may generate keys, in addition to the above.

Terminal device 400 communicates with other terminal devices (with terminal device 300), and performs random number generation processing, signature verification processing, and session key generation processing, for instance.

Note that FIG. 2 is a diagram for illustrating an overview of a communication system according to another example of the embodiment. In this example, common key issuing devices 200 are managed and operated by users of terminal devices 300 and 400 in order that common key issuing devices 200 can be individually connected to terminal devices 300 and 400.

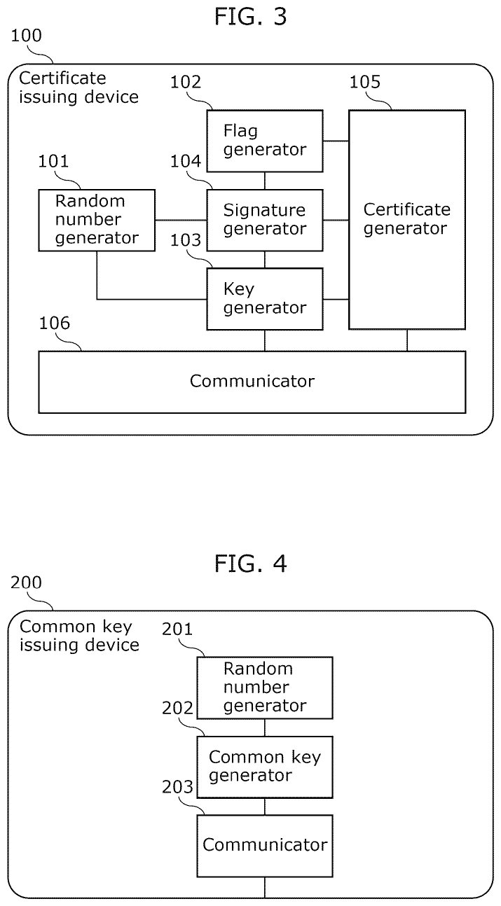

FIG. 3 is a block diagram illustrating an example of a functional configuration of certificate issuing device 100 according to the embodiment. Certificate issuing device 100 is implemented by a processor, a memory, and a predetermined program stored in the memory. Certificate issuing device 100 generates a digital signature certificate for use by a user and transmits the certificate to terminal devices 300 and 400. Certificate issuing device 100 includes, as a functional configuration, random number generator 101, flag generator 102, key generator 103, signature generator 104, certificate generator 105, and communicator 106.

Random number generator 101 performs random number generation processing, notifies key generator 103 of generated random number A, and notifies signature generator 104 of generated random number B. Note that random number A and random number B may be different from each other. The random numbers may not be uniform random numbers.

Flag generator 102 performs processing for generating a flag indicating that a certificate supports a plurality of algorithms (specifically, the algorithms mean encryption schemes), and notifies signature generator 104 and certificate generator 105 of the flag. Note that flags may be in a binary format, an integer-value format, or another format. The flags may be predetermined flags or other flags. Various types of flags may be generated according to the types of and the number of algorithms supported by the certificate.

Key generator 103 performs processing for generating secret key A, public key B, secret key C, and public key D, notifies signature generator 104 of secret key A and public key D, notifies certificate generator 105 of public key D, and notifies communicator 106 of public key B and secret key C. Terminal device 400 is notified of public key B, and terminal device 300 is notified of secret key C. Note that key generator 103 may generate any number of secret keys and public keys, and may generate a common key.

Signature generator 104 performs, using secret key A, signature processing on a plaintext that includes public key D and the flag notified by flag generator 102, and notifies certificate generator 105 of the generated signature. Note that any number of signatures may be generated, and the present embodiment does not limit the number of secret keys to be used to generate one or more signatures for any number of plaintexts. A plaintext may include a public key or a common key that are notified from terminal device 300.

Certificate generator 105 generates a certificate that includes the flag notified from flag generator 102, the signature notified from signature generator 104, and public key D notified from key generator 103, and notifies communicator 106 of the certificate to notify terminal device 300 of the certificate.

FIG. 4 is a block diagram illustrating an example of a functional configuration of common key issuing device 200 according to the embodiment. Common key issuing device 200 is implemented by a processor, a memory, and a predetermined program stored in the memory. Common key issuing device 200 generates different common keys for terminal devices 300 and 400 that the user uses and embeds the common keys in terminal devices 300 and 400. Common key issuing device 200 includes random number generator 201, common key generator 202, and communicator 203, as a functional configuration.

Random number generator 201 performs random number generation processing, and notifies common key generator 202 of the generated random number. Note that random number generator 201 may generate a plurality of random numbers, which may not be uniform random numbers.

Common key generator 202 performs common key generation processing, and notifies communicator 203 of the generated common key. Note that common key generator 202 may generate a plurality of common keys. Note that as illustrated in FIG. 2, according to another example of the embodiment, common key issuing device 200 may be provided in each of terminal devices 300 and 400 of the users.

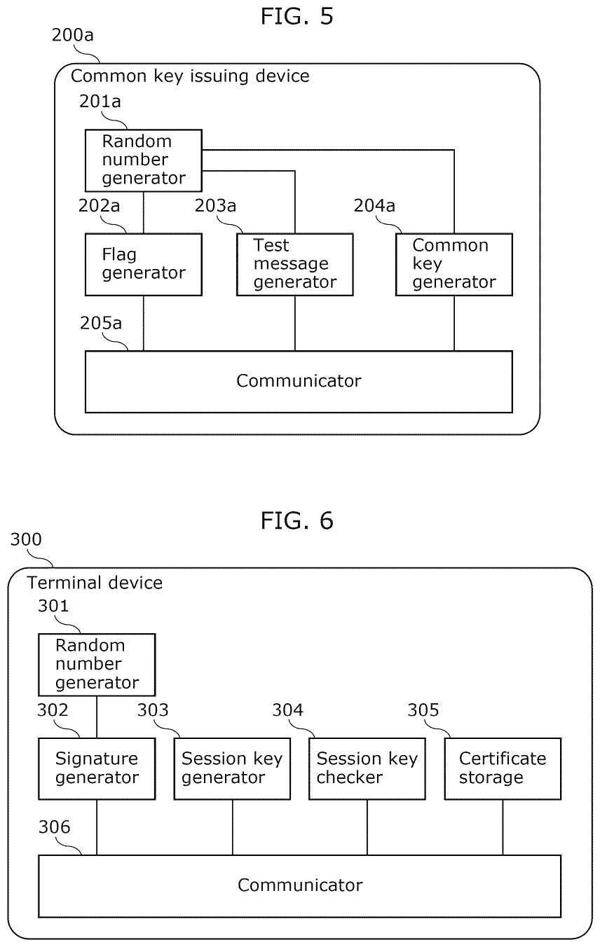

FIG. 5 is a block diagram illustrating another example of a functional configuration of common key issuing device 200a according to the embodiment. Common key issuing device 200a may generate a common test message and a common flag for terminal devices 300 and 400 that users use, and embed the test message and the flag in terminal devices 300 and 400. This is applied to the case of the configuration illustrated in FIG. 1, for example. Common key issuing device 200a in this example includes random number generator 201a, flag generator 202a, test message generator 203a, common key generator 204a, and communicator 205a, as a functional configuration.

Random number generator 201a performs random number generation processing, notifies flag generator 202a of generated random number A, notifies test message generator 203a of generated random number B, and notifies common key generator 204a of generated random number C. Note that random number A, random number B, and random number C may be different from one another. The random numbers may not be uniform random numbers.

Flag generator 202a performs processing for generating a flag indicating that the certificate supports a plurality of algorithms, and notifies communicator 205a of the flag. Note that the flag may be in a binary format, an integer-value format, or another format. The flag may be predetermined or may not be predetermined. Various types of flags may be generated according to the types and number of algorithms supported by the certificate.

Test message generator 203a performs processing for generating a test message, and notifies communicator 205a of the test message. Note that the test message may be in a binary format, an integer-value format, or another format. The test message may be predetermined or may not be predetermined. Various types of test messages may be generated according to the intended use.

Common key generator 204a performs common key generation processing, and notifies communicator 205a of the generated common key. Note that common key generator 204a may generate a plurality of common keys.

FIG. 6 is a block diagram illustrating an example of a functional configuration of terminal device 300 according to the embodiment. Terminal device 300 is implemented by a processor, a memory, and a predetermined program stored in the memory. Terminal device 300 communicates with other terminal devices, performs random number generation processing, signature generation processing, and session key generation processing, for instance. Terminal device 300 includes, as a functional configuration, random number generator 301, signature generator 302, session key generator 303, session key checker 304, certificate storage 305, and communicator 306.

Random number generator 301 performs signature generation processing, and notifies signature generator 302 of a generated random number. Note that random number generator 301 may generate a plurality of random numbers, which may not be uniform random numbers.

Signature generator 302 performs signature processing, using secret key C notified from key generator 103, on a plaintext that includes a flag and a nonce, and notifies communicator 306 of the generated signature to notify terminal device 400 of the generated signature. Note that any number of signatures may be generated, and the present embodiment does not particularly limit the number of secret keys to be used to generate one or more signatures for any number of plaintexts. The plaintext may not include a flag or a nonce, and the signature may not be generated using secret key C notified from key generator 103.

Session key generator 303 performs processing for generating a session key for exchanging keys, and notifies communicator 306 of the session key to notify terminal device 400 of the session key. Note that a plurality of session keys may be generated, and a test message encrypted together with the plurality of session keys may be notified.

Session key checker 304 performs processing for checking the session key notified from session key generator 303, and notifies communicator 306 of the result of the checking. Note that session key checker 304 may check a plurality of session keys, and may also check items other than the session key(s) notified from session key generator 303.

Certificate storage 305 stores therein a certificate notified from certificate generator 105. Certificate storage 305 further notifies communicator 306 of the certificate as necessary, to notify terminal device 400 of the certificate.

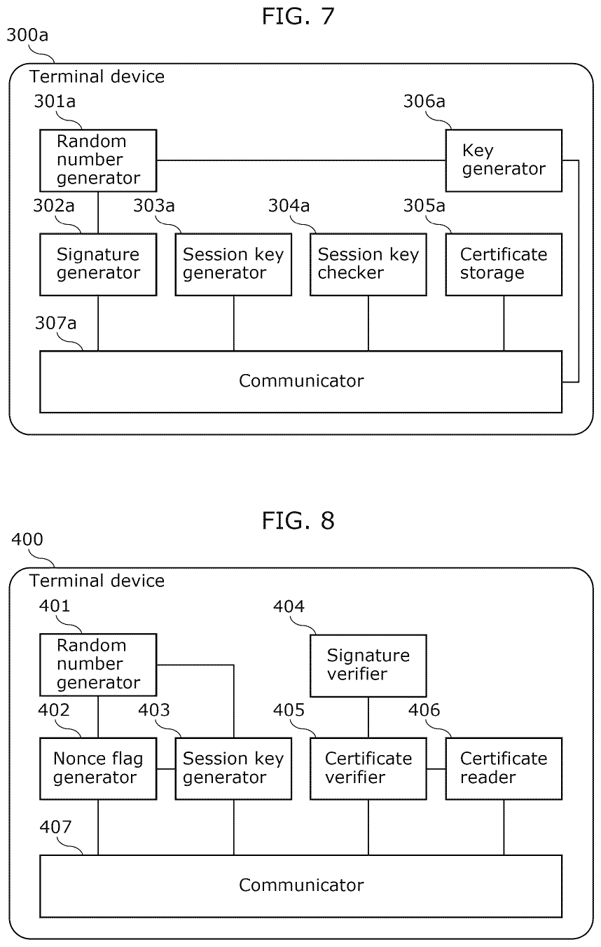

FIG. 7 is a block diagram illustrating another example of a functional configuration of terminal device 300a according to the embodiment. Terminal device 300a may generate keys. Terminal device 300a in this example includes, as a functional configuration, random number generator 301a, signature generator 302a, session key generator 303a, session key checker 304a, certificate storage 305a, key generator 306a, and communicator 307a. The functions of random number generator 301a, signature generator 302a, session key generator 303a, session key checker 304a, certificate storage 305a, and communicator 307a are equivalent to the functions of random number generator 301, signature generator 302, session key generator 303, session key checker 304, certificate storage 305, and communicator 306, and thus description thereof is omitted.

Key generator 306a performs processing for generating secret key C and public key D, and notifies communicator 307a of the generated keys to notify certificate issuing device 100 thereof. Note that key generator 306a may generate any number of secret keys and public keys, and may generate a common key.

FIG. 8 is a block diagram illustrating an example of a functional configuration of terminal device 400 according to the embodiment. Terminal device 400 is implemented by a processor, a memory, and a predetermined program stored in the memory. Terminal device 400 communicates with other terminal devices, performs random number generation processing, signature verification processing, and session key generation processing, for instance. Terminal device 400 includes, as a functional configuration, random number generator 401, nonce flag generator 402, session key generator 403, signature verifier 404, certificate verifier 405, certificate reader 406, and communicator 407.

Random number generator 401 performs random number generation processing, notifies nonce flag generator 402 of generated random number A, and notifies session key generator 403 of generated random number B. Note that random number A and random number B may be different from each other. The random numbers may not be uniform random numbers.

Nonce flag generator 402 performs processing for generating a flag for notifying attack detection and a nonce that is used for a signature. Nonce flag generator 402 notifies communicator 407 of the nonce to notify terminal device 300 thereof. Nonce flag generator 402 notifies session key generator 403 of the flag. Note that nonce flag generator 402 does not necessarily generate both a nonce and a flag and may generate one of them. A plurality of nonces and flags of a plurality of types may be generated.

Signature verifier 404 performs processing for verifying a signature notified from certificate verifier 405, and notifies certificate verifier 405 of the result of the verification. Note that signature verifier 404 may verify any number of signatures.

According to a certificate notified from certificate reader 406 and a method for verifying the certificate, certificate verifier 405 extracts a signature portion of the certificate necessary for the verification and notifies signature verifier 404 of the extracted signature portion. Note that certificate verifier 405 may verify any number of certificates.

Certificate reader 406 analyzes the certificate notified from certificate storage 305, and reads whether a flag is included, the number and type(s) of signatures, and the number and type(s) of public keys, for instance. Furthermore, according to the read information, certificate reader 406 determines a method for verifying a certificate (the order of verifying signatures, for example), and notifies certificate verifier 405 of the determined method and the certificate.

### Operation

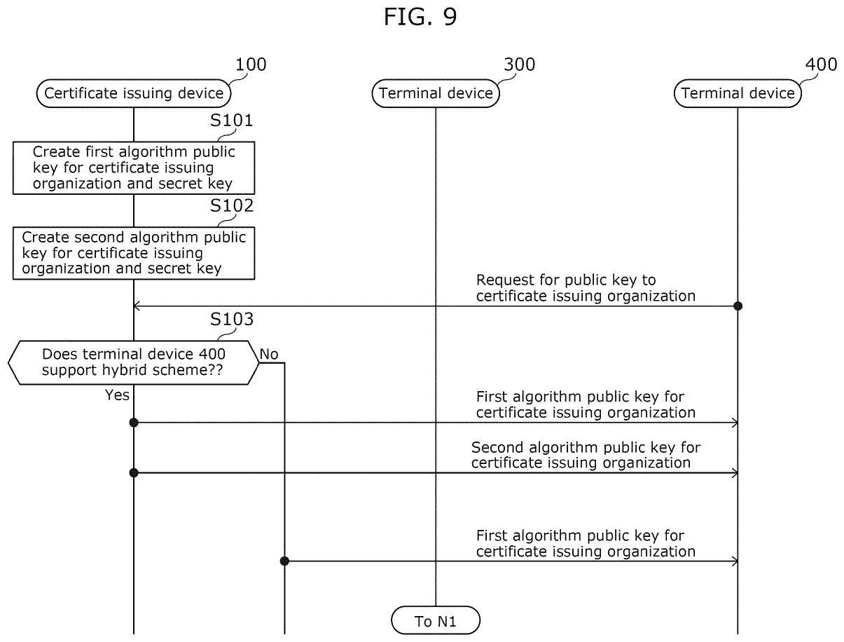

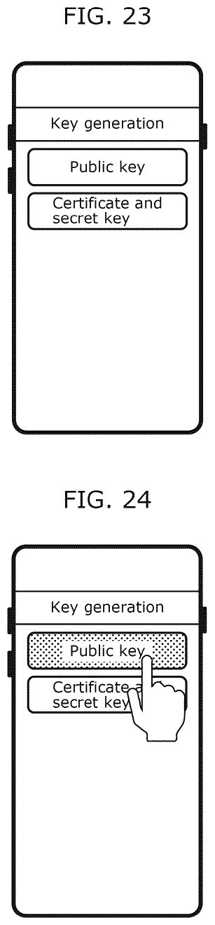

Next, operation of a communication system according to the embodiment is to be described. FIG. 9 to FIG. 22 are sequence diagrams illustrating examples of operation of the communication system according to the embodiment. FIG. 23 to FIG. 52 illustrate examples of screen display in operation of the communication system according to the embodiment.

When the operation of the communication system starts, first, certificate issuing device 100 creates a first algorithm public key for a certificate issuing organization and a secret key (S101). Specifically, key generator 103 creates the public key and the secret key. Certificate issuing device 100 creates a second algorithm public key for the certificate issuing organization and a secret key (S102). Specifically, key generator 103 creates the public key and the secret key.

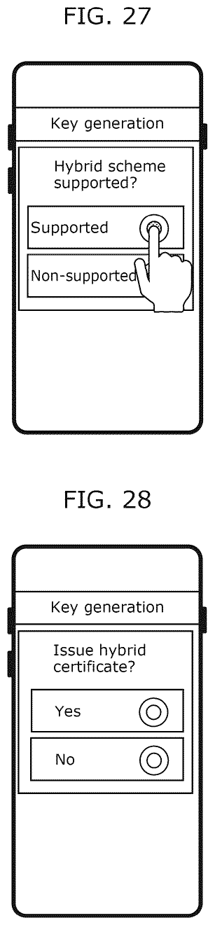

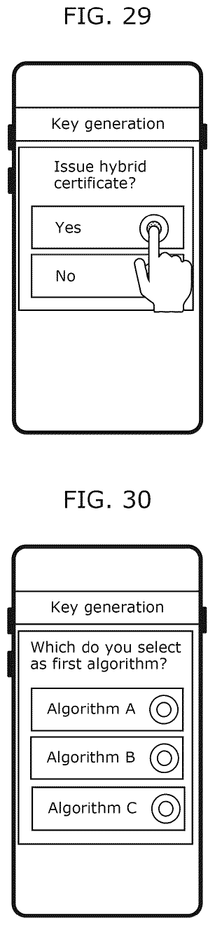

Here, terminal device 400 transmits a request for a public key for the certificate issuing organization to certificate issuing device 100. For example, terminal device 400 displays a screen for setting key generation as illustrated in FIG. 23, and transmits a request for a public key for the certificate issuing organization by selecting “Public key” as illustrated in FIG. 24. Certificate issuing device 100 determines whether terminal device 400 supports a hybrid scheme (S103). For example, terminal device 400 displays a screen for inputting whether the hybrid scheme is supported as illustrated in FIG. 26, and selects “Supported” as illustrated in FIG. 27. Then, the screen transitions to a screen for selecting whether to issue a hybrid certificate as illustrated in FIG. 28, and by selecting “Yes” as illustrated in FIG. 29, the communication system receives an input indicating that the hybrid scheme is supported.

When it is determined that terminal device 400 supports the hybrid scheme (“Supported” in S103), certificate issuing device 100 transmits, to terminal device 400, the first algorithm public key for the certificate issuing organization and the second algorithm public key for the certificate issuing organization.

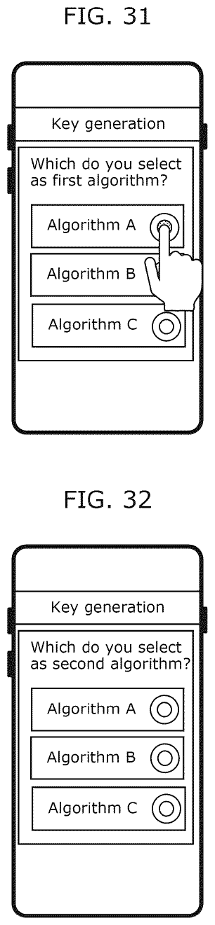

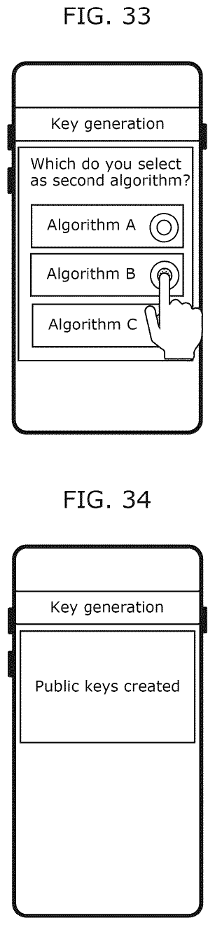

After selecting “Yes” as illustrated in FIG. 29 on the screen illustrated in FIG. 28, the screen transitions to a screen for selecting a first algorithm from among several options as illustrated in FIG. 30, for example. First, “Algorithm A” is assumed to be selected as the first algorithm from among several options as illustrated in FIG. 31, for example. Next, as illustrated in FIG. 32, the screen transitions to a screen for selecting a second algorithm from among several options. For example, assuming that “Algorithm B” is selected from among several options as illustrated in FIG. 33, a first algorithm public key for the certificate issuing organization for “Algorithm A” and a second algorithm public key for the certificate issuing organization for “Algorithm B” are created, and the screen illustrated in FIG. 34 is displayed.

On the other hand, when it is determined that terminal device 400 does not support the hybrid scheme (“No” in S103), certificate issuing device 100 transmits, to terminal device 400, only the first algorithm public key for the certificate issuing organization.

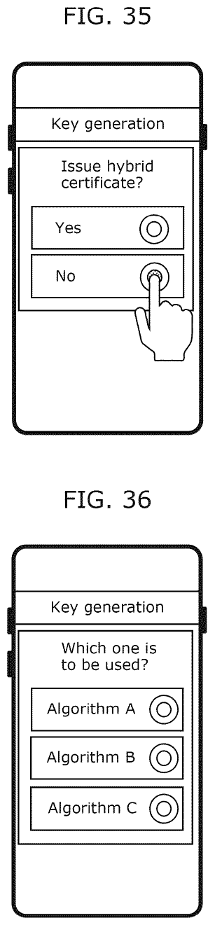

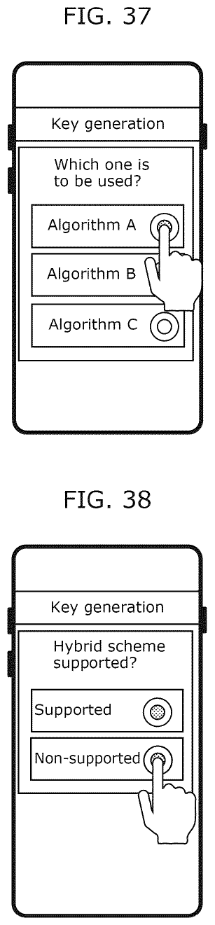

For example, after selecting “No” as illustrated in FIG. 35 on the screen illustrated in FIG. 28, the screen transitions to a screen for selecting a first algorithm from among several options as illustrated in FIG. 36, for example. For example, assuming that “Algorithm A” is selected as the first algorithm from among several options as illustrated in FIG. 37, a first algorithm public key for the certificate issuing organization for “Algorithm A” is created, and the screen illustrated in FIG. 34 is displayed.

For example, also when “Non-supported” is selected as illustrated in FIG. 38 on the screen illustrated in FIG. 26, the screen transitions to the screen illustrated in FIG. 36, transitions to the screen illustrated in FIG. 37, and transitions to the screen illustrated in FIG. 34.

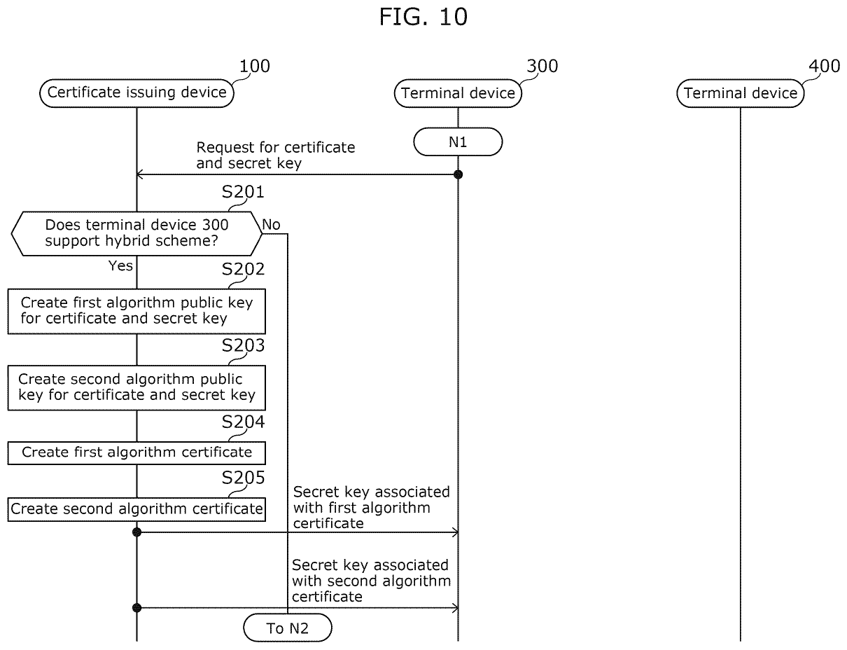

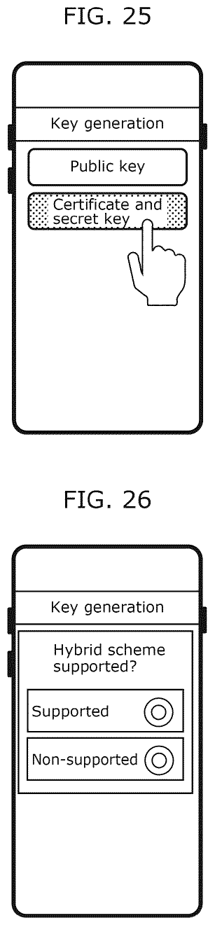

The processing proceeds to N1 in FIG. 10, terminal device 300 transmits a request for a certificate and a secret key to certificate issuing device 100. For example, terminal device 300 displays a screen for setting key generation as illustrated in FIG. 23, and transmits a request for a certificate and a secret key by selecting “Certificate and secret key” as illustrated in FIG. 25. Certificate issuing device 100 determines whether terminal device 300 supports a hybrid scheme (S201). For example, terminal device 300 displays a screen for inputting whether the hybrid scheme is supported as illustrated in FIG. 26, and selects “Supported” as illustrated in FIG. 27. Then, the screen transitions to a screen for selecting whether to issue a hybrid certificate as illustrated in FIG. 28, and by selecting “Yes” as illustrated in FIG. 29, the communication system receives an input indicating that the hybrid scheme is supported. In the following processing, transitions of the screens in FIG. 30 to FIG. 38 are similar to those of terminal device 400, and thus description thereof is omitted.

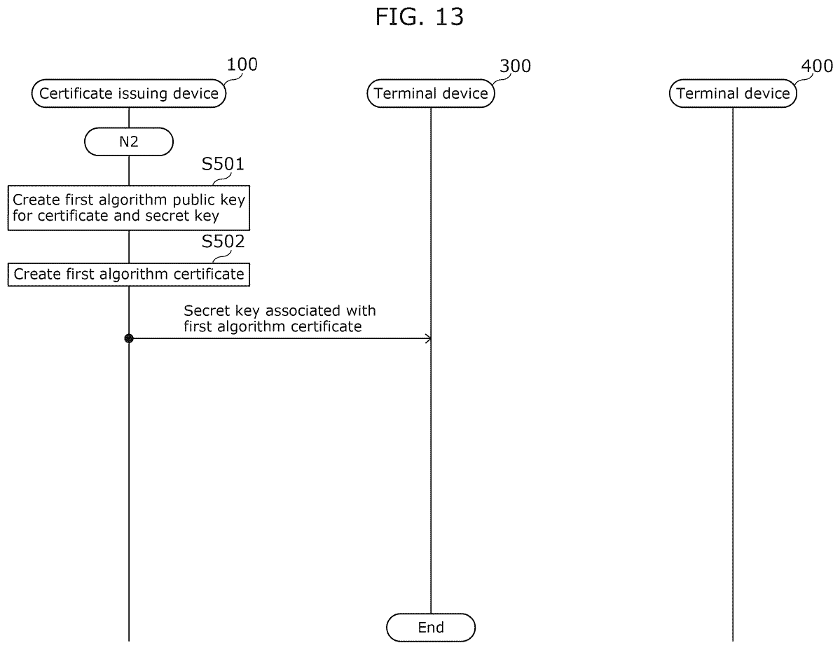

When it is determined that terminal device 300 supports the hybrid scheme (“Yes” in S201), certificate issuing device 100 creates a first algorithm public key for a certificate and a secret key (S202). Certificate issuing device 100 further creates a second algorithm public key for a certificate and a secret key (S203). Certificate issuing device 100 creates a first algorithm certificate (S204). Certificate issuing device 100 further creates a second algorithm certificate (S205). Certificate issuing device 100 transmits, to terminal device 300, a secret key associated with the first algorithm certificate and a secret key associated with the second algorithm certificate. On the other hand, when it is determined that terminal device 300 does not support the hybrid scheme (Non-supported” in S201), the processing proceeds to N2 in FIG. 13. FIG. 13 is to be described later.

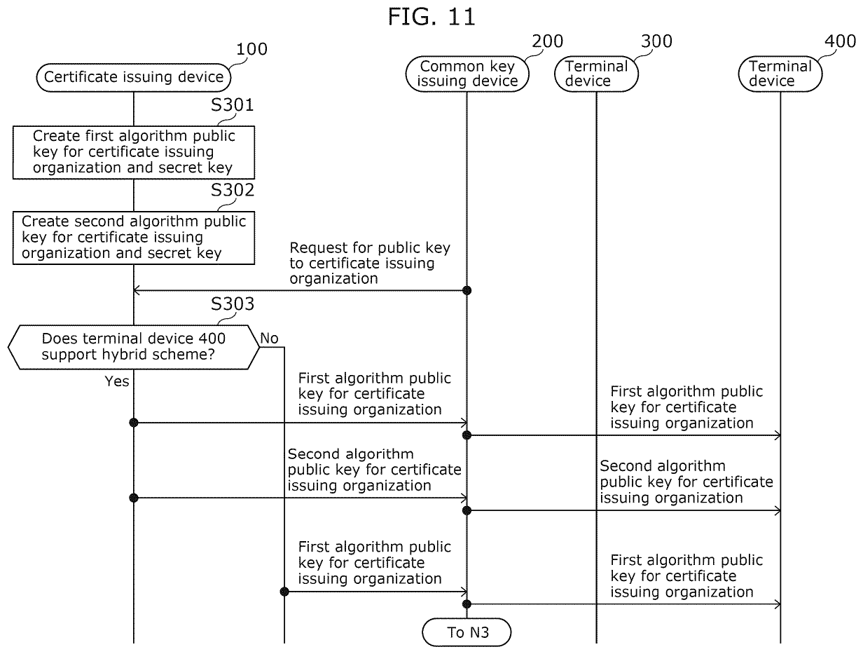

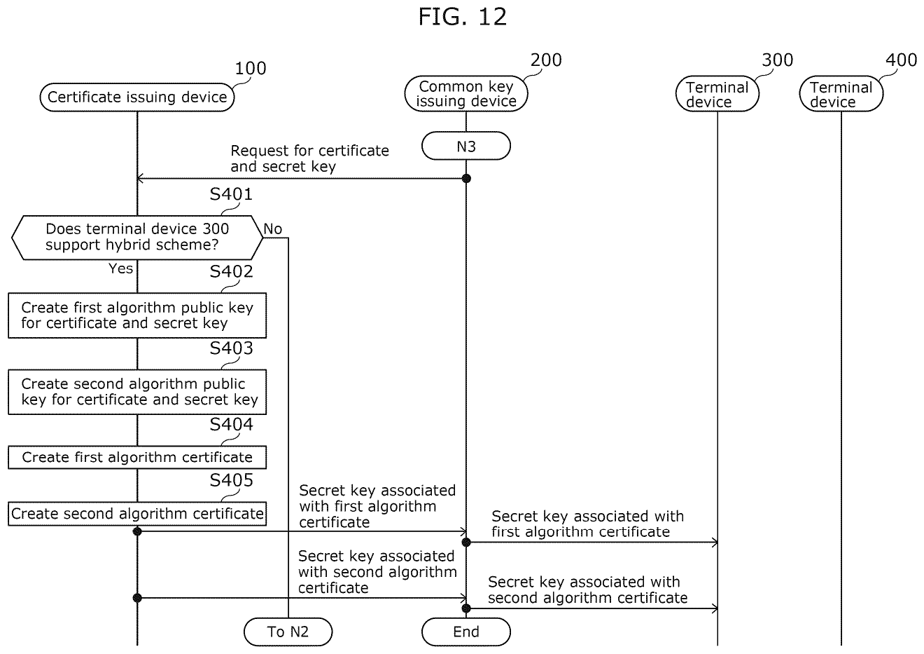

Here, FIG. 11 and FIG. 12 illustrate other examples of the above operation. More specifically, common key issuing device 200 performs part of the above processing. Note that in the operation according to the other examples, terminal device 400 and terminal device 300 may display screens as illustrated in FIG. 23 to FIG. 38 and receive user operations on the screens. For example, as compared with FIG. 9, FIG. 11 illustrates that common key issuing device 200 transmits a request for a public key for the certificate issuing organization to certificate issuing device 100. Note that steps S301 and S302 are the same as steps S101 and S102, respectively, and thus description thereof is omitted. Certificate issuing device 100 determines whether terminal device 400 supports the hybrid scheme, similarly to step S103 (S303). When it is determined that terminal device 400 supports the hybrid scheme (“Yes” in S303), certificate issuing device 100 transmits, to terminal device 400 via common key issuing device 200, the first algorithm public key for the certificate issuing organization and the second algorithm public key for the certificate issuing organization. On the other hand, when it is determined that terminal device 400 does not support the hybrid scheme (“No” in S303), certificate issuing device 100 transmits, to terminal device 400 via common key issuing device 200, only the first algorithm public key for the certificate issuing organization.

The processing proceeds to N3 in FIG. 12, here, common key issuing device 200 transmits a request for a certificate and a secret key to certificate issuing device 100. Certificate issuing device 100 determines whether terminal device 300 supports the hybrid scheme, similarly to step S201 (S401). Steps S402 to S405 are the same as steps S202 to S205, respectively, and thus description thereof is omitted. When it is determined that terminal device 300 supports the hybrid scheme (“Yes” in S401), certificate issuing device 100 performs processing in steps S402 to S405, and thereafter transmits, to terminal device 300 via common key issuing device 200, a secret key associated with the first algorithm certificate and a secret key associated with the second algorithm certificate. When it is determined that terminal device 300 does not support the hybrid scheme (No” in S401), the processing proceeds to N2 in FIG. 13.

As illustrated in FIG. 13, when the result of step S201 in FIG. 10 is “No” or the result of step S401 in FIG. 12 is “No”, certificate issuing device 100 creates a first algorithm public key for a certificate and a secret key (S501). Certificate issuing device 100 creates a first algorithm certificate (S502), and transmits, to terminal device 300, the first algorithm certificate and a secret key associated therewith. After that, the processing ends.

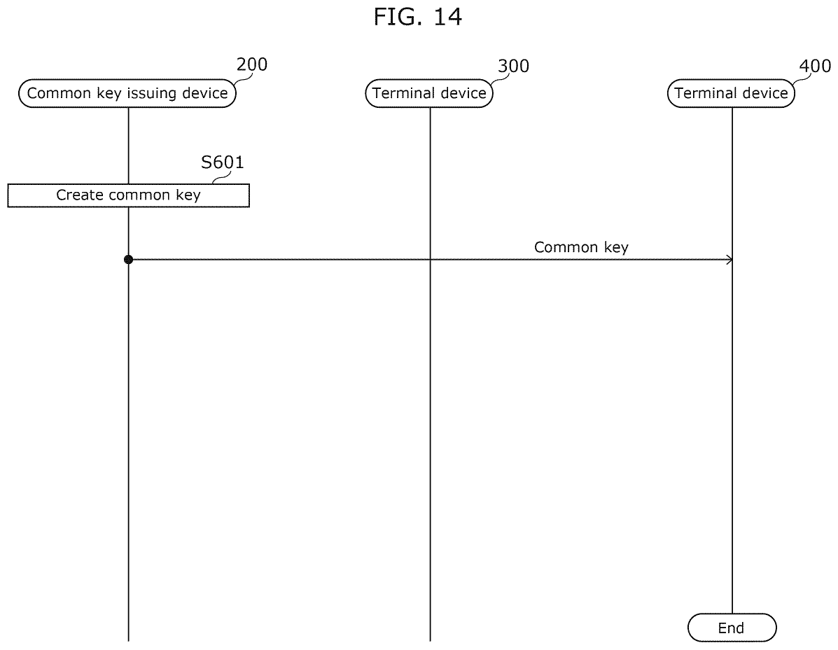

Note that in the case of the configuration illustrated in FIG. 4, common key issuing device 200 creates a common key (S601) and transmits the common key to terminal device 400, as illustrated in FIG. 14. After that, the processing ends.

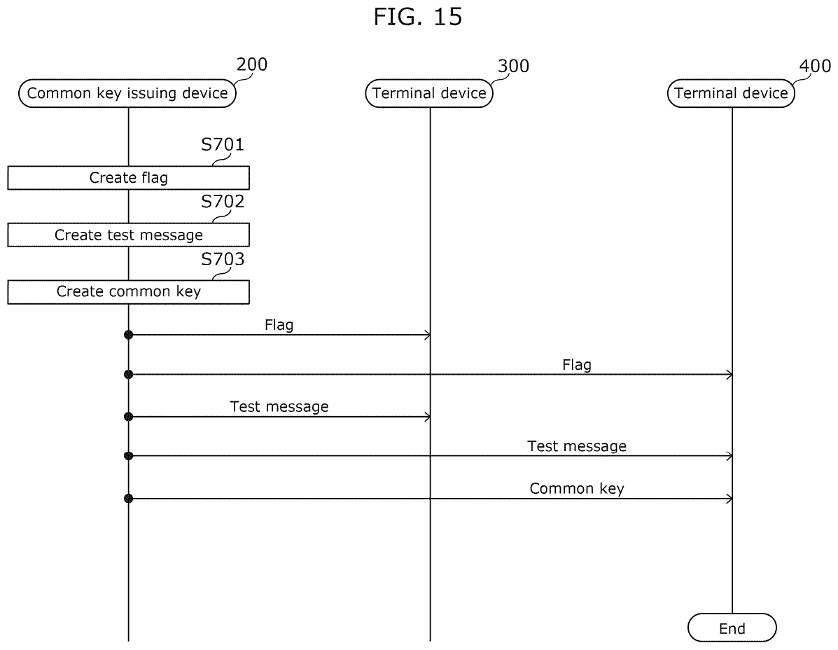

Furthermore, in the case of the configuration illustrated in FIG. 5, common key issuing device 200 creates a flag (S701), creates a test message (S702), and creates a common key (S703), as illustrated in FIG. 15. Then, common key issuing device 200 transmits the flag to terminal devices 300 and 400. Common key issuing device 200 further transmits the test message to terminal devices 300 and 400. Then, common key issuing device 200 transmits the common key to terminal device 400. After that, the processing ends.

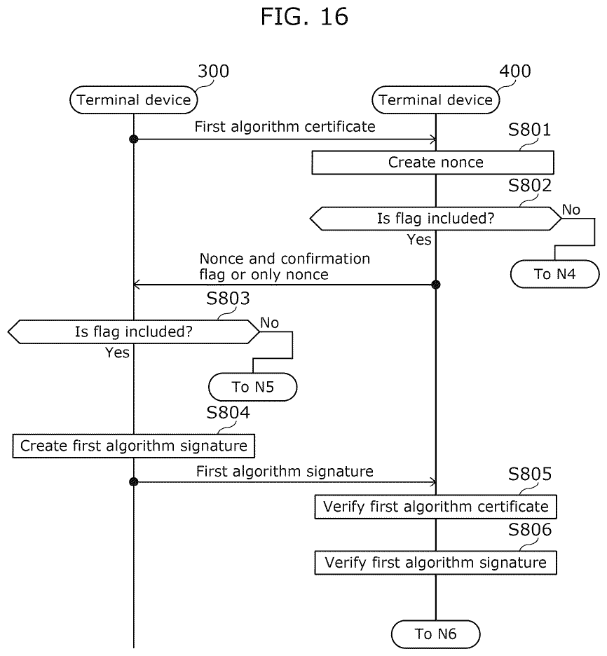

Next, as illustrated in FIG. 16, pre-communication for checking whether terminal device 300 and terminal device 400 can communicate with each other under the hybrid scheme is performed. First, terminal device 300 transmits a first algorithm certificate to terminal device 400. At this time, the first algorithm certificate includes, in a non-critical expansion region, a confirmation flag indicating that hybrid communication, or in other words, an encryption scheme that is a combination of a classic scheme (a first encryption scheme) and a PQC scheme (a second encryption scheme) is supported. More accurately, with this communication method, when the first algorithm certificate is issued, the first algorithm certificate includes a confirmation flag in a non-critical expansion region.

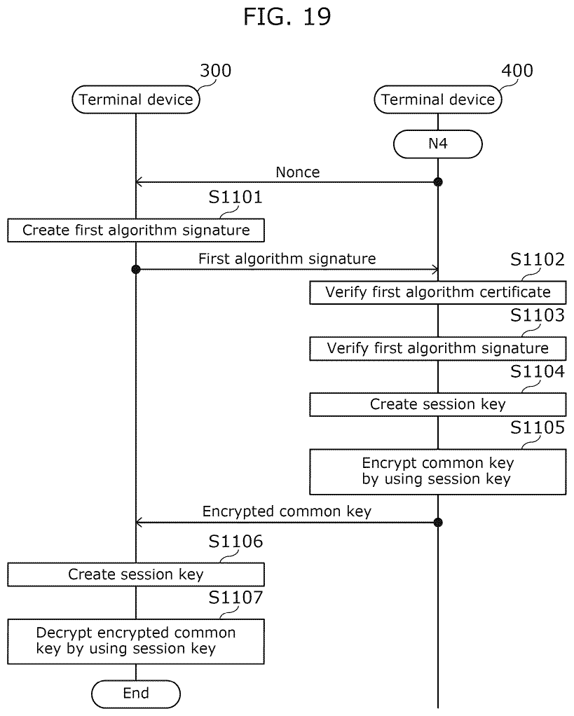

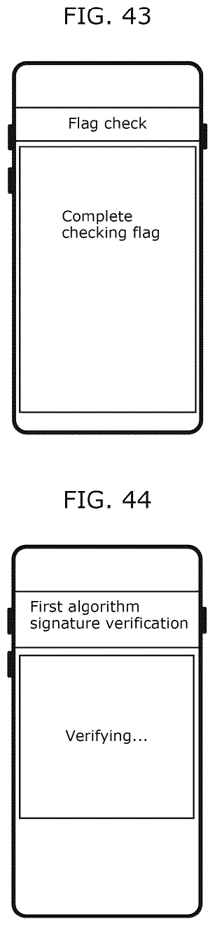

Terminal device 400 creates a nonce when the first algorithm certificate is received (S801). Here, terminal device 400 generates a nonce and a confirmation flag if terminal device 400 supports the hybrid scheme, whereas terminal device 400 generates only a nonce if terminal device 400 does not support the hybrid scheme. Accordingly, if the flag is determined not to be included (“No” in S802) in the determination as to whether a flag (a confirmation flag) is included (S802), this shows that terminal device 400 does not support the hybrid scheme. In this case, the processing proceeds to N4 in FIG. 19. FIG. 19 is to be described later. For example, a screen for checking whether a flag is included as illustrated in FIG. 40 is displayed on terminal device 400, so that it can be checked that no flag is included. Then, the screen transitions to the screen illustrated in FIG. 43.

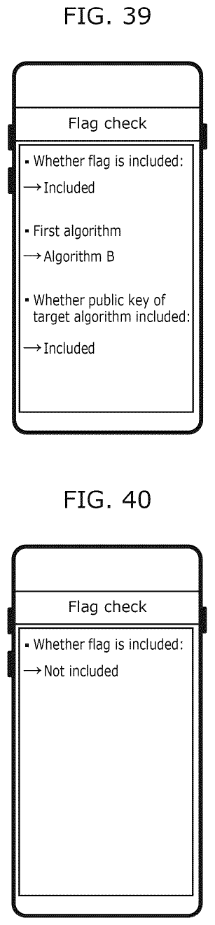

On the other hand, if it is determined that a flag is included (“Yes” in S802), this shows that terminal device 400 supports the hybrid scheme. For example, a screen for checking whether a flag is included as illustrated in FIG. 39 is displayed on terminal device 400, so that it can be checked that a flag is included. Then, the screen transitions to the screen illustrated in FIG. 43. As a response to the certificate, terminal device 400 transmits, to terminal device 300, a nonce and a confirmation flag, or only a nonce. The nonce is a random number of 128 bits, for example.

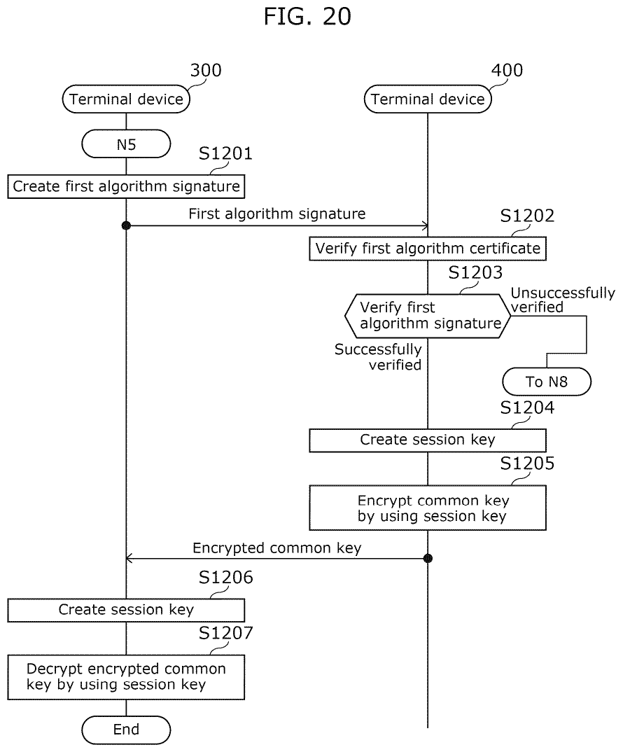

Terminal device 300 determines whether a flag is included (S803), and if a flag is determined not to be included (“No” in S803), this shows that terminal device 400 does not support the hybrid scheme. In this case, the processing proceeds to N5 in FIG. 20. FIG. 20 is to be described later. For example, a screen for checking whether a flag is included as illustrated in FIG. 42 is displayed on terminal device 300, so that it can be checked that no flag is included. Then, the screen transitions to the screen illustrated in FIG. 43, and the processing ends.

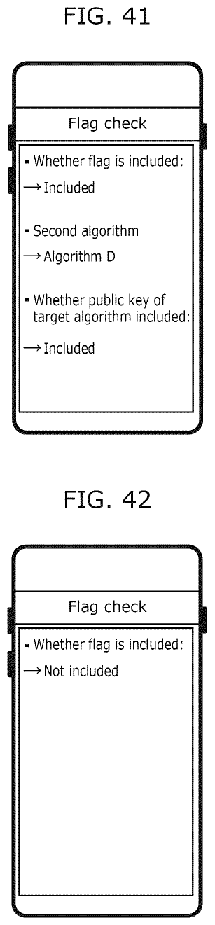

On the other hand, if it is determined that a flag is included (“Yes” in S803), this shows that terminal device 400 supports the hybrid scheme. For example, a screen for checking whether a flag is included as illustrated in FIG. 41 is displayed on terminal device 300, so that it can be checked that a flag is included. Then, the screen transitions to the screen illustrated in FIG. 43. Terminal device 300 creates a first algorithm signature (S804). Specifically, terminal device 300 generates a first algorithm signature by applying a signature under a classic encryption scheme such as an elliptic curve digital signature algorithm (EC-DSA) to a value resulting from combining the nonce, the confirmation flag, and a session key.

Terminal device 300 transmits the generated first algorithm signature to terminal device 400. Terminal device 400 verifies the first algorithm certificate (S805). At this time, a public key associated with a secret key is extracted. Next, terminal device 400 verifies the first algorithm signature (S806). For this verification, the extracted public key is used.

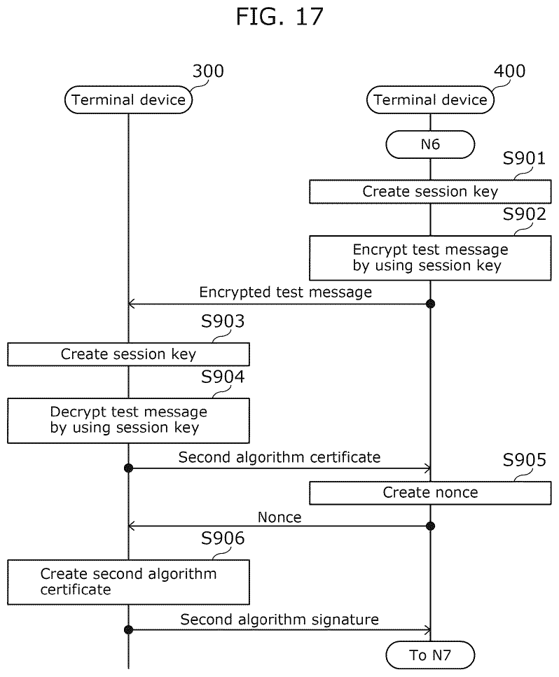

The processing proceeds to N6 in FIG. 17, and terminal device 400 creates a session key (S901). Specifically, terminal device 400 generates a 128-bit common key from the public key received from terminal device 300 and the secret key generated by terminal device 400. Terminal device 400 encrypts the common key used for communication between terminal devices 300 and 400 and a test message, by using the session key (S902). Specifically, terminal device 400 encrypts the common key and the test message by using the generated 128-bit key under the Advanced Encryption Standard (AES) scheme, and transmits the encrypted key and test message. Terminal device 400 transmits the encrypted test message to terminal device 300. Terminal device 300 creates a session key (S903). Specifically, terminal device 300 further decrypts the common key and the test message by using the session key (S904). After that, terminal device 300 decrypts the encrypted common key received and verifies the test message.

Then, terminal device 300 transmits a second algorithm certificate to terminal device 400. Terminal device 400 creates a nonce (S905) and transmits the created nonce to terminal device 300. Terminal device 300 creates a second algorithm signature (S906) and transmits the created second algorithm signature to terminal device 400.

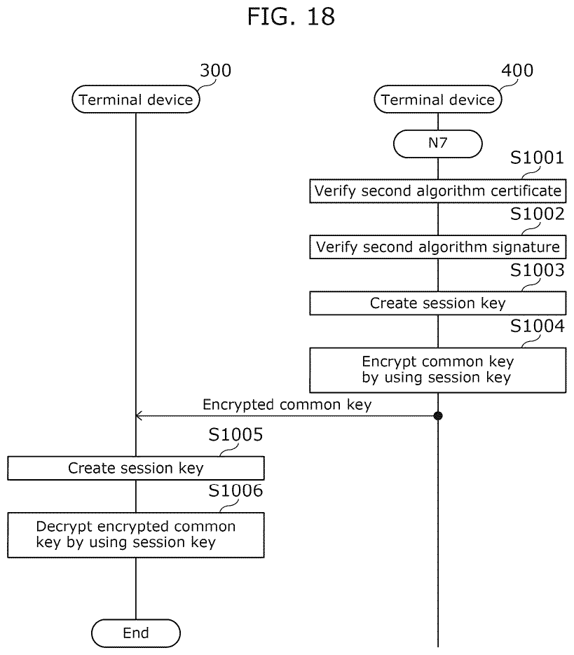

The processing proceeds to N7 in FIG. 18, and terminal device 400 verifies the second algorithm certificate (S1001). Next, terminal device 400 verifies the second algorithm signature (S1002). After that, terminal device 400 creates a session key (S1003), and encrypts a common key using the created session key (S1004). Terminal device 400 transmits the encrypted common key to terminal device 300. Terminal device 300 creates a session key (S1005), and decrypts the encrypted common key using the session key (S1006). In this manner, communication under the hybrid scheme is established (pre-communication processing for support checking ends).

Here, the operation after N4 in FIG. 19 is to be described. After the determination shows “No” in step S802, terminal device 400 transmits a nonce to terminal device 300. Terminal device 300 operates to establish communication according to the first algorithm since terminal device 400 does not support the hybrid scheme. First, terminal device 300 creates a first algorithm signature (S1101). Terminal device 300 transmits the created first algorithm signature to terminal device 400.

Terminal device 400 verifies the first algorithm certificate (S1102), verifies the first algorithm signature (S1103), and creates a session key (S1104). Terminal device 400 encrypts a common key by using the created session key (S1105). Terminal device 400 transmits the encrypted common key to terminal device 300. Terminal device 300 creates a session key (S1106), and decrypts the encrypted common key using the session key (S1107). Accordingly, communication according to the first algorithm (that is, the classic scheme) is established (pre-communication processing for support checking ends).

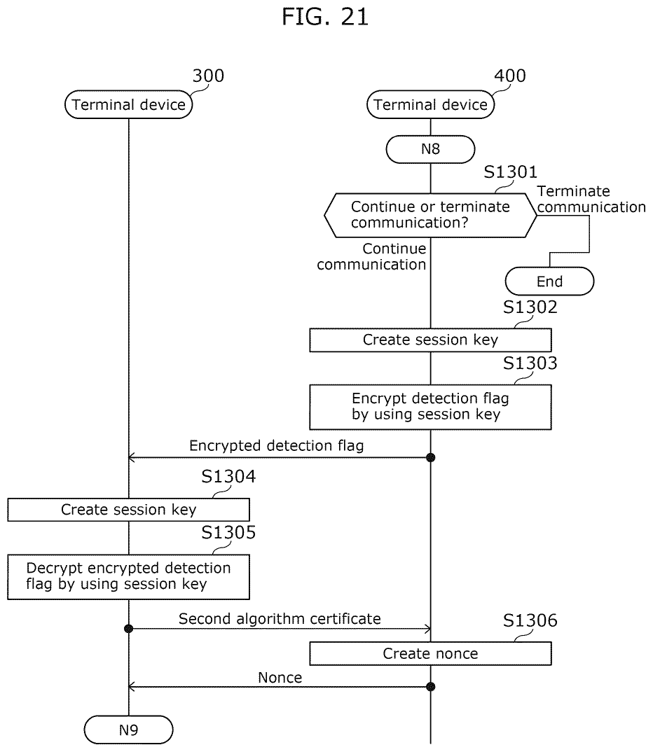

Furthermore, the operation after N5 in FIG. 20 is to be described. When the determination in step S803 shows “No”, terminal device 300 creates a first algorithm signature (S1201). Terminal device 300 transmits the created first algorithm signature to terminal device 400. Terminal device 400 verifies the first algorithm certificate (S1202), and verifies the first algorithm signature (S1203). For example, a screen for verifying the first algorithm signature illustrated in FIG. 44 is displayed. If verification is unsuccessful at this time (“Verification unsuccessful” in step S1203), the processing proceeds to N8 in FIG. 21. FIG. 21 is to be described later.

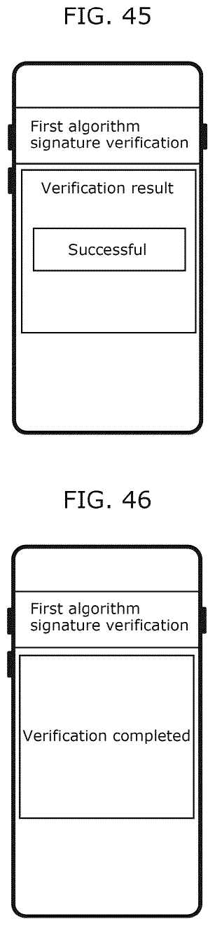

When the verification of the first algorithm signature is successful (“Successfully verified” in step S1203), the processing proceeds to creation of a session key (S1204). For example, a screen showing that the result of the verification is “Successful” as illustrated in FIG. 45 is displayed, and the screen transitions to the screen showing that the verification has ended as illustrated in FIG. 46. Terminal device 400 encrypts a common key by using the created session key (S1205). Terminal device 400 transmits the encrypted common key to terminal device 300. Terminal device 300 creates a session key (S1206), and decrypts the encrypted common key using the session key (S1207). Accordingly, communication according to the first algorithm (that is, the classic scheme) is established (pre-communication processing for support checking ends).

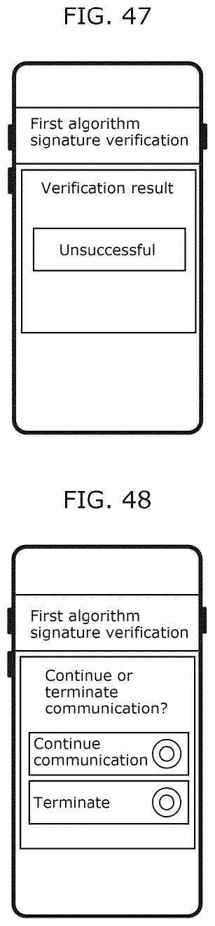

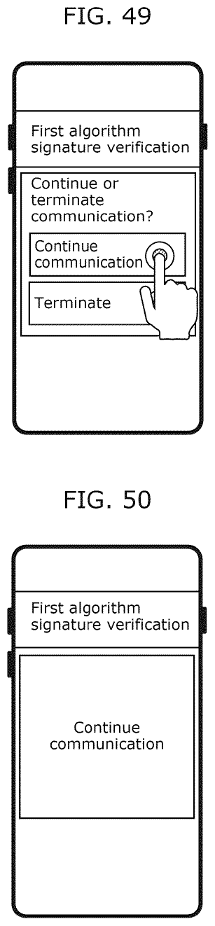

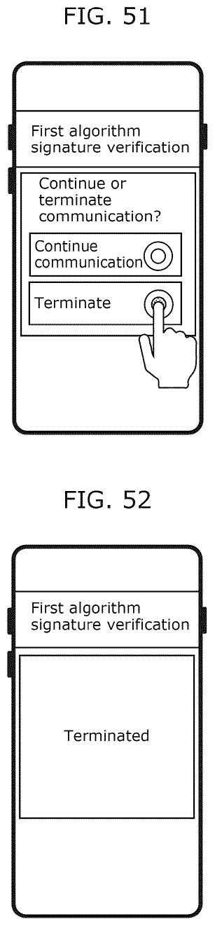

Next, the operation after N8 in FIG. 21 is to be described. When the verification of the first algorithm signature is unsuccessful (“Unsuccessfully verified in S1203), terminal device 400 determines whether to continue or terminate the communication (S1301). For example, the screen showing that the result of the verification is “Unsuccessful” as illustrated in FIG. 47 is displayed, and transitions to the screen for selecting whether to continue or terminate the communication as illustrated in FIG. 48. When terminal device 400 determines that the communication is to be terminated (“Terminate communication” in S1301), the communication terminates and all the processes end. For example, when “Terminate” is selected as illustrated in FIG. 51, the screen transitions to the screen showing that the communication has terminated as illustrated in FIG. 52. On the other hand, when terminal device 400 determines to continue the communication (“Continue communication” in S1301), terminal device 400 creates a session key (S1302). For example, when “Continue communication” is selected as illustrated in FIG. 49, the screen transitions to the screen showing that the communication continues as illustrated in FIG. 50. Terminal device 400 encrypts a detection flag by using the created session key (S1303). The detection flag shows that a message has been tampered with. Hence, an attacker may have changed the communication to the one under the classical scheme, and thus if the communication is to continue, the communication may continue under the PQC scheme. Accordingly, in the following, the communication is to be switched to the one under the second algorithm corresponding to the PQC scheme.

Terminal device 400 transmits the encrypted detection flag to terminal device 300. Terminal device 400 creates a session key (S1304), and decrypts the encrypted detection flag using the session key (S1305). In this manner, terminal device 300 detects that tampering has been made, by receiving the detection flag. After that, terminal device 300 transmits a second algorithm certificate to terminal device 400. Terminal device 400 creates a nonce (S1306) and transmits the created nonce to terminal device 300.

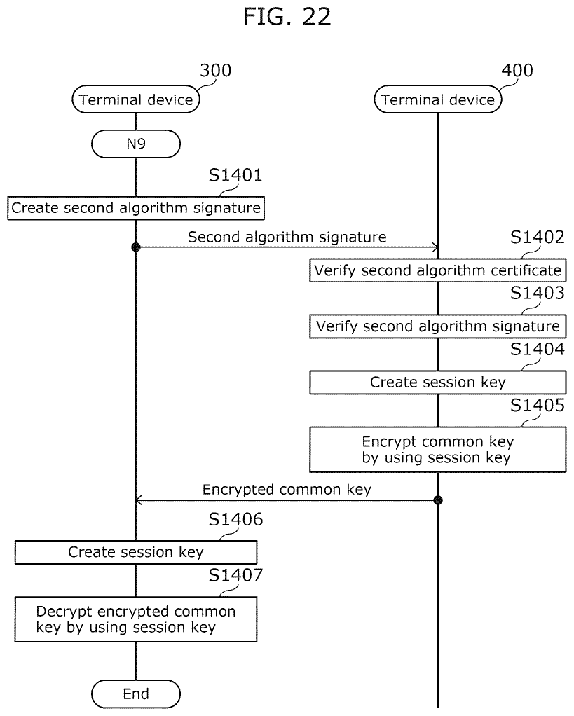

The processing proceeds to N9 in FIG. 22, terminal device 300 creates a second algorithm signature (S1401), and transmits the created second algorithm signature to terminal device 400. Terminal device 400 verifies the second algorithm certificate (S1402). Next, terminal device 400 verifies the second algorithm signature (S1403). After that, terminal device 400 creates a session key (S1404), and encrypts a common key using the created session key (S1405). Terminal device 400 transmits the encrypted common key to terminal device 300. Terminal device 300 creates a session key (S1406), and decrypts the encrypted common key using the session key (S1407). In this manner, communication under the PQC scheme is established (pre-communication processing for support checking ends).

### Variation

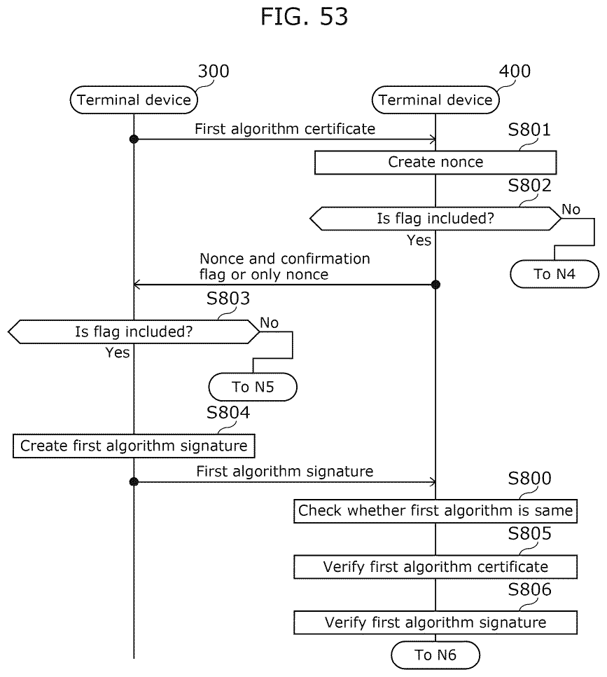

In a variation described below, FIG. 53 to FIG. 56 corresponding to FIG. 16, FIG. 17, FIG. 19, and FIG. 20 in the above embodiment are used for the description. Compared with the above embodiment, the description focuses on different points and omits the same points. FIG. 53 to FIG. 56 are sequence diagrams illustrating examples of operation of the communication system according to the variation of the embodiment.

The above embodiment has described that the first algorithm and the second algorithm are selected from among several options and used, as illustrated in FIG. 30 to FIG. 33, FIG. 36, and FIG. 37. The selected algorithm needs to be the same for terminal device 300 and terminal device 400, but at that time, terminal device 300 and terminal device 400 may have a function for checking with the communication system whether the algorithm selected is the same. In view of this, in the communication system according to the variation, steps (S800, S900, S1100, and S1200) for checking whether the algorithm is the same are additionally included in addition to the operation described with reference to FIG. 16 to FIG. 20.

FIG. 53 corresponds to FIG. 16, and a step (S800) for checking whether the algorithm is the same is additionally included in addition to the operation of the communication system illustrated in FIG. 16. Here, after transmitting, to terminal device 400, a first algorithm signature generated by terminal device 300, terminal device 400 checks whether the first algorithm is the same (S800). Terminal device 300 may check whether an algorithm that is scheduled to be used as the first algorithm is the same as an algorithm selected by terminal device 400 as the first algorithm.

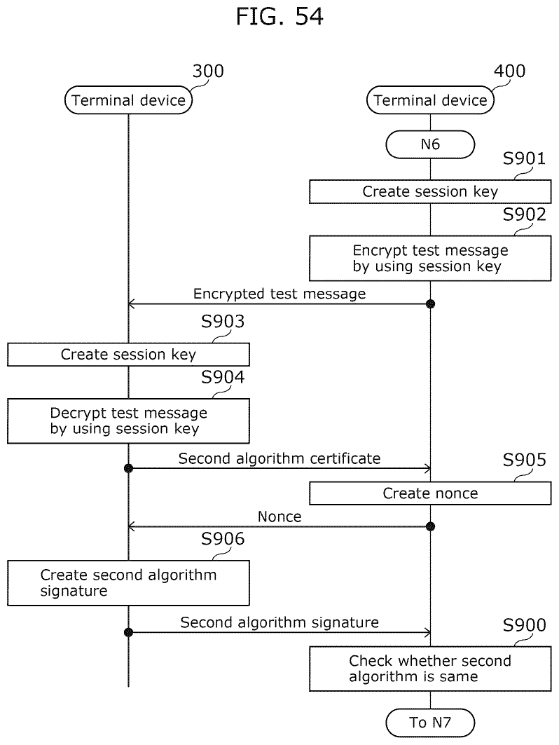

FIG. 54 corresponds to FIG. 17, and a step (S900) for checking whether the algorithm is the same is additionally included in addition to the operation of the communication system illustrated in FIG. 17. Here, after transmitting, to terminal device 400, a second algorithm signature generated by terminal device 300, terminal device 400 checks whether the second algorithm is the same (S900). Terminal device 300 may check whether an algorithm that is scheduled to be used as the second algorithm is the same as an algorithm selected by terminal device 400 as the second algorithm.

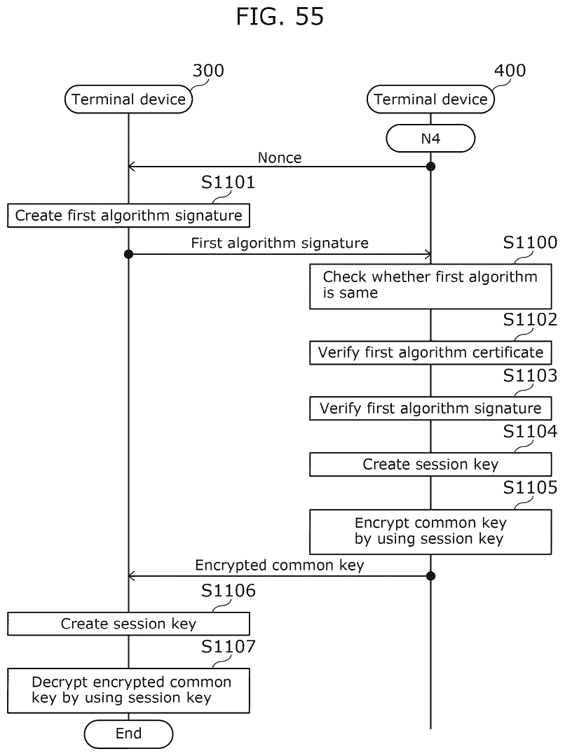

FIG. 55 corresponds to FIG. 19, and a step (S1100) for checking whether the algorithm is the same is additionally included in addition to the operation of the communication system illustrated in FIG. 19. Here, after transmitting, to terminal device 400, the first algorithm signature generated by terminal device 300, terminal device 400 checks whether the first algorithm is the same (S1100). Terminal device 300 may check whether an algorithm that is scheduled to be used as the first algorithm is the same as an algorithm selected by terminal device 400 as the first algorithm.

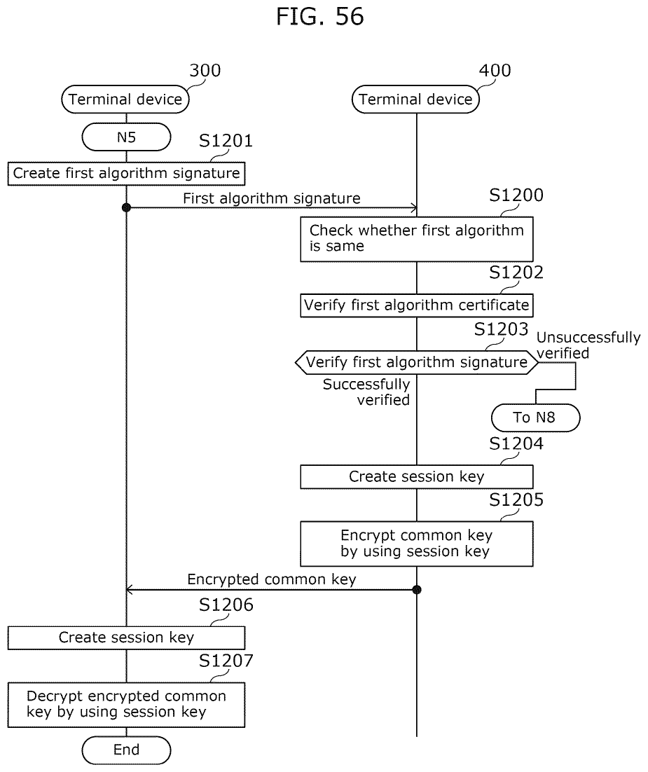

FIG. 56 corresponds to FIG. 20, and a step (S1200) for checking whether the algorithm is the same is additionally included in addition to the operation of the communication system illustrated in FIG. 20. Here, after transmitting, to terminal device 400, a first algorithm signature generated by terminal device 300, terminal device 400 checks whether the first algorithm is the same (S1200). Terminal device 300 may check whether an algorithm that is scheduled to be used as the first algorithm is the same as an algorithm selected by terminal device 400 as the first algorithm.

### Other Embodiments

In the above embodiment, when the processing proceeds to “Yes” in step S802, this state indicates that terminal device 300 and terminal device 400 both support the second algorithm. For example, in a circumstance in which the PQC scheme may be solely used such as after the safety of the PQC scheme has been sufficiently evaluated, when terminal device 300 and terminal device 400 both support the second algorithm (“Yes” in step S802), only processing for communication under the second algorithm (processing from transmitting the second algorithm certificate after step S904) may be performed without performing processing for the communication under the first algorithm.

In the above embodiments, each of the elements may be acquired using dedicated hardware, or may be obtained by executing a software program suitable for the element. Each element may be acquired using a program executor such as a CPU or a processor reading out and executing a software program recorded on a recording medium such as a hard disk or semiconductor memory.

Each element may be a circuit (or an integrated circuit). Such circuits may constitute a single circuit as a whole or may be separate circuits. These circuits may be widely used circuits or dedicated circuits.

A general or specific aspect of the present disclosure may be implemented by a system, a device, a method, an integrated circuit, a computer program, or a computer-readable non-transitory recording medium such as a CD-ROM, or may be achieved by any combination of systems, devices, methods, integrated circuits, computer programs, or computer-readable non-transitory recording media.

For example, the present disclosure may be implemented as a communication method executed by various devices (computers or Demand-Side Platforms (DSPs)) involved in communication or may be implemented as a program for causing a computer or a DSP to execute the above communication method.

Furthermore, a process that a particular processing element executes may be executed by another processing element. The processing order of processes in the operation of the communication system described in the above embodiment may be changed or the processes may be executed in parallel.

The present disclosure includes embodiments as a result of applying, to the embodiments, various modifications that may be conceived by those skilled in the art, and embodiments obtained by combining elements and functions in embodiments in any manner without departing from the scope of the present disclosure.

### INDUSTRIAL APPLICABILITY

The present disclosure is useful as, for instance, a communication method when the hybrid scheme is applied.

1. A communication method for use in a first device in communication between the first device and a second device, the communication method comprising:
transmitting, by the first device, a certificate for a first encryption scheme to the second device, the certificate including a confirmation flag indicating that the first device supports a different encryption scheme from the first encryption scheme;
when the first device receives a message that includes a nonce and the confirmation flag as a response from the second device to transmission of the certificate, transmitting, by the first device to the second device, a signature generated based on the nonce and the confirmation flag that are included in the message received; and
when the first device receives a message that includes a nonce and does not include the confirmation flag as a response from the second device to transmission of the certificate, transmitting, by the first device to the second device, a signature generated based on the nonce included in the message received.

2. The communication method according to claim 1,
wherein when the first device receives a detection flag indicating that the message has been tampered with, the first device continues a communication session between the first device and the second device by using the different encryption scheme, the detection flag being generated by the second device, based on a mismatch between the message transmitted by the second device as the response to the transmission of the certificate and the signature transmitted by the first device to the second device in response to reception of the message.

3. The communication method according to claim 1,
wherein when the first device receives a detection flag indicating that the message has been tampered with, the first device terminates a communication session between the first device and the second device, the detection flag being generated by the second device, based on a mismatch between the message transmitted by the second device as the response to the transmission of the certificate and the signature transmitted by the first device to the second device in response to reception of the message.

4. The communication method according to claim 1,
wherein the first encryption scheme is a Rivest-Shamir-Adleman (RSA) scheme or an Elliptic Curve Digital Signature Algorithm (ECDSA) scheme, and
the different encryption scheme is a Post Quantum Cryptography (PQC) scheme.

5. A communication method for use in a second device in communication between a first device and the second device, the communication method comprising:
receiving, by the second device, a certificate for a first encryption scheme from the first device, the certificate including a confirmation flag indicating that the first device supports a different encryption scheme from the first encryption scheme;
when the second device supports the different encryption scheme, transmitting, by the second device to the first device, a message that includes a nonce and the confirmation flag as a response to the certificate received;
when the second device does not support the different encryption scheme, transmitting, by the second device to the first device, a message that includes a nonce and does not include the confirmation flag as a response to the certificate received; and
receiving, by the second device from the first device, a signature generated based on the nonce included in the message transmitted or a signature generated based on the nonce and the confirmation flag that are included in the message transmitted.

6. A first device communicable with a second device, the first device comprising:
a certificate generator that generates a certificate for a first encryption scheme, the certificate including a confirmation flag indicating that the first device supports a different encryption scheme from the first encryption scheme; and
a signature generator,
wherein when the first device transmits the certificate generated to the second device and receives a message that includes a nonce and the confirmation flag as a response from the second device, the signature generator generates a signature, based on the nonce and the confirmation flag that are included in the message received, and
when the first device transmits the certificate generated to the second device and receives a message that includes a nonce and does not include the confirmation flag as a response from the second device, the signature generator generates a signature, based on the nonce included in the message received.

7. A second device communicable with a first device, the second device comprising:
a message generator; and
a communicator,
wherein when the message generator receives a certificate for a first encryption scheme from the first device, the certificate including a confirmation flag indicating that the first device supports a different encryption scheme from the first encryption scheme,
the message generator generates a message that includes a nonce and the confirmation flag as a response to the certificate received, under a condition that the second device supports the different encryption scheme, and
the message generator generates a message that includes a nonce and does not include the confirmation flag as a response to the certificate received, under a condition that the second device does not support the different encryption scheme, and
the communicator receives, from the first device, a signature generated based on the nonce included in the message transmitted or a signature generated based on the nonce and the confirmation flag that are included in the message transmitted.
